(19) United States
(12) Patent Application Publication
(10) Pub. No.: US 2009/0050209 A1
(43) Pub. Date: Feb. 26, 2009

(54) APPARATUS AND METHOD FOR FILLING A BATHTUB

(75) Inventors: Janne RAUTAVUORI, Lappi (FI); Pekka Nilsson, Rauma (FI)

Correspondence Address: YOUNG & THOMPSON, 209 Madison Street, Suite 500, ALEXANDRIA, VA, 22314, US

(73) Assignee: ORAS OY, Rauma (FI)

(21) Appl. No.: 12/196,299

(22) Filed: Aug. 22, 2008

(30) Foreign Application Priority Data
Aug. 23, 2007 (FI) 20070639

(51) Int. Cl. F16K 31/46; E03B 1/00

(52) U.S. Cl. 137/2; 137/624.11

(57) ABSTRACT

An apparatus for filling a bathtub (1) at least partially with water (10), includes an electronic faucet (4), at which terminate hot and cold water supply pipes (6, 7) and from which extends at least one bathtub filling pipe (8), a remote controller (5), at least one temperature sensor (12) for bathwater, at least one water level sensor (11) for bathwater, and an antenna integrated with the electronic faucet (4). In addition, the respective method for filling a bathtub (1) at least partially with water (10) is also described.

The invention relates to an apparatus and method for filling a bathtub. More specifically, the invention relates to an apparatus and method for adjusting the temperature and water quantity of bathwater.

In prior art tubs, bathwater is run into the bathtub from a water supply network and the bathwater temperature is adjusted by turning manually a cold water faucet and a hot water faucet for establishing an appropriate water temperature. A problem is how to achieve a correct temperature whenever there is enough water in the tub for bathing. It is often necessary to drain water out through the tub's drain/overflow and to replenish the tub with tap water (hot or cold) to establish a proper bathwater temperature. Monitoring the water temperature is quite often performed manually by hand testing. The attainment of a necessary correct amount of water also calls for monitoring the tub filling process, at least towards the final stages of filling, in order to avoid unnecessary water flow by way of an overflow drain into the sewer.

On the other hand, there are prior known solutions, wherein bathtubs are associated with separate heating units for heating the bathwater already in the bathtub. Solutions of this type have been described, among others, in publications JP 61147051, JP 61008556 and JP 58198638. However, these publications do not provide a solution to the problem of how to fill a bathtub with a correct amount of water having a correct temperature.

The publication JP 61147051 discloses a unit designed for heating bathtub water, wherein the tub is replenished with water warmed up by means of an extra-tub heater. The amount of time needed for heating the extra-tub water quantity is anticipated on the basis of the amount of water present in an external water tank, the water temperature, and the atmospheric temperature. Once the water tank heating is completed, the warm water is added into the tub. The amount and temperature of warm water can be set by means of a control unit included in the heating system. Drawbacks in such a system include a need to have an external heater and hot water tank, as well as to arrange the same in communication with the tub. In addition, the system is inconvenient in terms of connecting it to a pre-existing tub, which has no necessary connections for pipes or the bathroom has no extra space required for the unit.

The publication JP 61008556 discloses a system for heating bathtub water, wherein the amount and temperature of water present in the tub are monitored by means of sensors. The obtained values are communicated along an information cable to a regulating unit, which determines a rate of heating necessary for the water in the tub and supplies more heated water from an external hot water tank, the heating of which is also regulated by the regulating unit. The unit described in this publication can even be located in a room other than the bathtub. However, this requires room-to-room installations of pipe and cable systems. In addition, the system is inconvenient in terms of connecting it to a pre-existing tub, which does not have necessary connections for the pipes.

The publication JP 58198368 discloses an apparatus, wherein bathtub water is circulated along a separate circulation system, i.e. the water discharged from the tub is warmed up by means of a heat exchanger and the water is returned along a filling pipe back into the tub. The amount of warm water to be replenished is monitored by means of a water quantity sensor and by means of a temperature sensor placed on the tub floor. An objective is to maintain the tub water at a set temperature. The apparatus includes a separate hot water tank, the hot water therein being used in the heat exchanger for heating the bathwater. Drawbacks in the apparatus include a large hot water tank, the water of which must be maintained hot. Connections for separate pipes are also needed in the tub and so is a heat exchanger in association therewith.

An apparatus and method according to the invention are capable of eliminating the prior art problems and enable a trouble-free achievement and regulation of a desired bathwater temperature without separate hot water boilers or other such Systems.

The invention employs sensors for monitoring the temperature and amount of bathwater in a bathtub, and the ratio between hot and cold water arriving from the water supply network is adjusted as the tub is filling. Thus, the amount of water in a bathtub is at a determined quantity and the water is at a determined temperature without having to monitor the tub filling process, after which the supply of water to the bathtub stops automatically. It is also possible to maintain a desired water quantity at a desired temperature while bathing or the water temperature can be readily adjusted for hotter or colder.

More specifically, the solution according to the invention is characterized by what is presented in the characterizing clauses of the independent claims. Furthermore, the sub-claims disclose optional embodiments for the invention.

Advantages offered by the invention include the automatic filling of a bathtub to a determined water level, the automatic supply of temperature-adjusted bathwater, the easy installation-readiness of the apparatus to all tubs with a standard-compliant overflow drain without separate external heaters/heat exchangers or extra pipe systems.

The invention will now be described more closely with reference to the accompanying drawings, in which

FIG. 1 shows an apparatus of the invention and part of a bathtub in a simplified cross-sectional view,

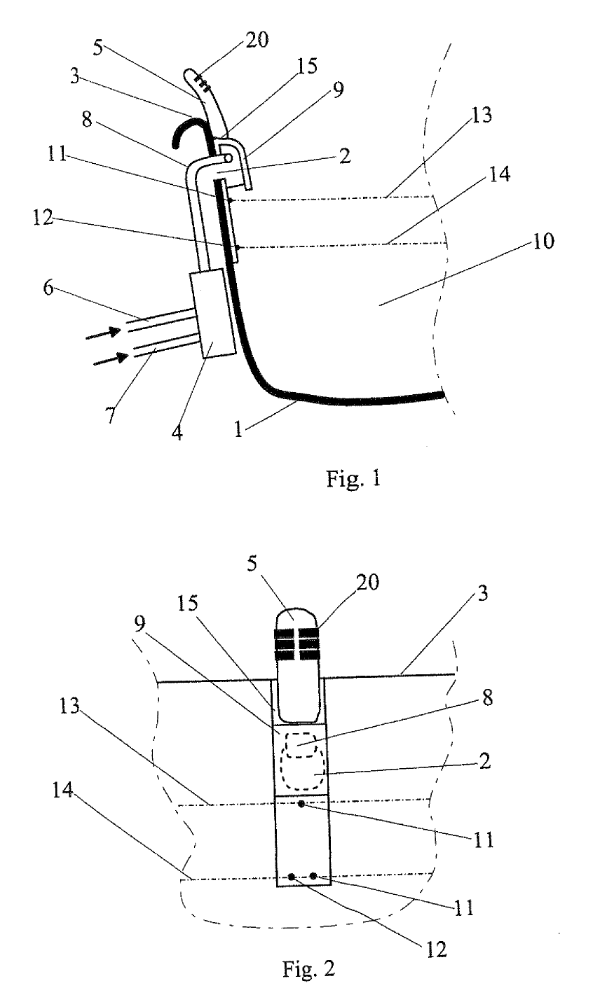

FIG. 2 shows one embodiment of the apparatus in a simplified view from inside a bathtub, and

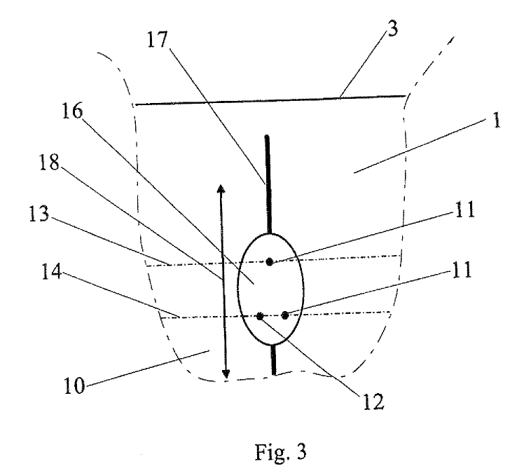

FIG. 3 shows an alternative embodiment for monitoring the water level and temperature.

In reference to FIG. 1, there is shown a bathtub 1, which has an overflow drain 2 consistent with the bathtub standard EN 232:2003, having a diameter of 52 mm and located near a top rim 3 of the bathtub. Such an overflow drain 2 exists in all bathtubs 1 complying with the bathtub standard EN 232:2003. In addition to these, the invention is feasible in all bathtubs which just have an overflow drain. The invention is applicable also to bathtubs without an overflow drain, as subsequently discussed. In the embodiment shown in FIG. 1, an electronic water faucet 4 for incoming water is placed next to a bathtub wall. The discussed electronic faucet is controlled (opened, adjusted, closed) by means of a remote controller 5. The remote controller 5 is preferably of a wireless design but, if desired, can also be a wired model. A wireless model is preferred. The remote controller 5 features necessary controls for establishing setups, means for transmitting the setups to the electronic faucet 4, and a display (not shown in the figure) for visualizing the established setups. The electronic faucet 4 has integrated therewith an antenna (not shown in the figure) for controlling the faucet/receiving the setups. Coming in to the faucet 4 from the water supply network are hot and cold water supply pipes 6 and 7, and extending therefrom is a bathtub filling pipe 8. The electronic faucet 4 mixes the incoming hot and cold water to provide water with a correct/adjusted temperature to be delivered along the bathtub filling pipe 8 into the bathtub 1. It is also feasible that the bathtub 1 be provided with separate filling pipes for both hot and cold water, but mixing the water in the faucet is preferred.

The bathtub filling pipe 8 is disposed in this embodiment in conjunction with the overflow drain 2, such that the bathroom has an appearance which provides an impression as neat as possible. The filling pipe 8 and the overflow drain 2 are placed behind a cover member 9 out of sight. However, the solution according to the invention does not limit positioning of the electronic faucet 4 and the filling pipe 8 to the above-specified locations, but, instead, the electronic faucet can be placed in an arbitrary position and the filling pipe can be installed anywhere in the bathtub 1. Being operated with the remote controller 5, the electronic faucet 4 provides favorable conditions for such arbitrary disposition.

The remote controller 5 can be used for determining a desired temperature and quantity for bathwater 10. The apparatus monitors the level of bathwater 10 in the bathtub 1 by means of a water level sensor/sensors 11. There may be one or more sensors 11 arranged in the bathtub 1 on various sides and at various heights. The temperature of bathwater 10 is monitored by means of a temperature sensor/sensors 12. The temperature sensors 12 can be disposed in undetermined numbers on the sides and/or floor of the bathtub 1. Besides, some of such sensors can be installed to float on the surface of bathwater 10. One option is to include a temperature sensor 12 in the remote controller 5 and to place the remote controller floating in the bathtub 1, whereby the remote controller transmits temperature information to the electronic faucet 4. It is further possible for the apparatus to take into consideration the cooling that occurs during a filling process, by monitoring the temperature of a room, by assessing the cooling effect of a tub, by assessing the effect of a filling time, etc.

A filling process of the bathtub 1 with bathwater 10 proceeds as follows. The electronic faucet 4 is opened with the remote controller 5 and a desired bathwater temperature and quantity are determined. The apparatus monitors the temperature and quantity of water in the above-discussed manner. Just before a determined water level 13, the apparatus checks the temperature of bathwater 10 and performs a necessary fine adjustment. This takes place after the water level has reached a so-called initial fill level 14, at which height are mounted the water level and temperature sensors 11 and 12. Upon reaching the determined water level 13, the electronic faucet 4 automatically shuts off the supply of bathwater 10 into the bathtub 1. The temperature of bathwater 10 in the bathtub 1 can be naturally adjusted also during a bath by adding hot or cold water into the bathtub. Excess water runs automatically out of the filled-up bathtub 1 either by way of the overflow drain 2 or, in case of using an incompletely filled tub, the amount of bathwater matching the added amount of water is discharged by way of a drain valve/outlet (not shown in the figure) in the bathtub floor. The bathtub 1 can also be drained automatically by using the remote controller 5 to open a drain valve/outlet in the bathtub floor for draining the bathwater 10 into the sewer system.

The remote controller 5 used for controlling the electronic faucet 4 can be held on top of the cover member 9 concealing the overflow drain 2 and the tip of the filling pipe 8 in a stand/position 15 designed for the purpose.

FIG. 2 shows the apparatus in a view from the bathtub 1. The remote controller 5 used for controlling the electronic faucet 4 is positioned on top of the cover member 9 concealing the overflow drain 2 and the tip of the supply pipe 8 in its own allocated position 15. The overflow drain 2 and the tip of the supply pipe 8 are behind the cover member 9 and shown in this FIG. 2 in dashed lines. The water level is monitored in this embodiment by two water level sensors 11. A first (lowermost) water level sensor 11 observes the so-called initial fill level 14, which is followed by a fine adjustment for the temperature of bathwater 10. At the same height can also be found a temperature sensor 12, from which the electronic faucet 4 receives information about the temperature of bathwater 10 for the fine adjustment. Above these sensors 11 and 12 is located a second (upper) sensor 11 for the final water level 13. When the surface of bathwater 10 reaches this (upper) sensor 11, the electronic faucet 4 automatically shuts off the supply of water.

The electronic faucet 4 according to the invention and the apparatus associated therewith enable an automatic filling process of the bathtub 1 on the basis of set initial values (amount of water and temperature), a temperature-adjustment of filling water, a service as the overflow drain 2, a service as an automatic filling controller, a water temperature tracking process, a remote control service, and a service as a stand for the remote controller 5. In addition, it is possible for the building's automation to perform monitoring and/or governing the electronic faucet by way of an antenna integrated with the faucet. Moreover, the bathtub draining occurs automatically with the remote controller, which enables opening the drain outlet/valve of a bathtub.

The disposition in a bathtub of sensors needed for tracking water level and temperature is by no means limited to the solutions set forth in the foregoing embodiments. One optional embodiment is, for example, that the three sensors of FIG. 2 (water level sensors 11 and a temperature sensor 12) will be mounted on a separate movable and/or removable tracking unit 16 and this tracking unit will be fixed on an internal surface of the bathtub 1 at a desired level from the bathtub's top rim 3 before the running of bathwater 10 is started, as depicted in FIG. 3. Thereby, a small number of sensors will be sufficient to perform monitoring actions necessary for the adjustment and to determine at will the initial fill level 14 and the final water level 13. Fixing of the tracking unit 16 to the side of a bathtub can be effected for example by using a magnet, a suction cup or by fitting the bathtub with a separate slide track or slideway 17, along which the tracking unit is movable in the bathtub 1 in an up/down sense, as indicated by an arrow 18. By moving the final water level sensor 11 of the tracking unit 16 to a desired height inside the bathtub, a desired degree of filling is always obtained in the bathtub 1. Information from the tracking unit 16 to the electronic faucet 4 is preferably communicated in a wireless manner, but a wired option is also available.

The apparatus according to the invention is feasible also in non-standard bathtubs, in which case the discharge of bathwater proceeds solely through a drain outlet/valve in the floor of a bathtub under the control of a remote controller. Thus, whenever it is desirable to change the temperature of bathwater without increasing the water quantity (or to maintain it at a specific temperature), the supply pipe will be used for adding hot or cold water and a corresponding volume of water is discharged by way of the drain.

It is obvious for a skilled artisan that embodiments of the invention are not limited to those described above, but may vary within the scope of protection defined in the appended claims.

1. An apparatus for filling a bathtub (1) at least partially with water (10), said apparatus comprising an electronic faucet (4), at which terminate hot and cold water supply pipes (6, 7) and from which extends at least one bathtub filling pipe (8), characterized in that the apparatus includes a remote controller (5), at least one temperature sensor (12) for bathwater, at least one water level sensor (11) for bathwater, and an antenna integrated with the electronic faucet (4).

2. An apparatus according to claim 1, characterized in that the apparatus has two water level sensors (11) at various heights on an internal surface of the bathtub (1), such that the lowermost sensor is set at a desired initial fill level (14) and the upper sensor is set at a desired final water level (13).

3. An apparatus according to claim 1, characterized in that the temperature sensor (12) is included in the remote controller (5).

4. An apparatus according to claim 1, characterized in that the temperature sensor(s) (12) and/or the water level sensor(s) (11) are mounted in a stationary manner.

5. An apparatus according to claim 1 characterized in that the temperature sensor (12) floats on the surface of bathwater (10).

6. An apparatus according to claim 1, characterized in that the temperature sensor(s) (12) and/or the water level sensor(s) (11) are mounted on a movable tracking unit (18).

7. An apparatus according to claim 6, characterized in that the tracking unit (18) is fixed to the tub (1) with a magnet, a suction cup, a slide track, a slideway or the like.

8. An apparatus according to claim 1, characterized in that the bathtub (1) features a standard-compliant overflow drain (2).

9. An apparatus according to claim 1, characterized in that the overflow drain (2) and the supply pipe's tip (8) are behind a cover member (9).

10. An apparatus according to claim 1, characterized in that the apparatus' cover member (9) serves also as a stand (15) for the remote controller (5).

11. An apparatus according to claim 1, characterized in that the apparatus includes a sensor for the temperature of a room.

12. An apparatus according to claim 1, characterized in that the apparatus is installation-ready to all presently existing, as well as to new bathtubs (1).

13. A method for filling a bathtub (1) at least partially with water (10), said method comprising the following steps of:
providing an electronic faucet (4),
providing a hot and cold water supply (6, 7) to the electronic faucet (4),
providing at least one filling pipe (8) for delivering water of a desired temperature from the electronic faucet (4) into the bathtub (1),
characterized in that the method further includes the following steps of:
providing the electronic faucet (4) with an integrated antenna,
using a remote controller (5) for setting the temperature and quantity of bathwater (10) produced by the electronic faucet (4),
using the remote controller (5) for opening the electronic faucet (4),
monitoring the water level with at least one sensor (11) and adjusting it, if necessary, on the basis of received information,
monitoring the temperature of water (10) with at least one sensor (12) and adjusting it, if necessary, on the basis of received information,
shutting off the electronic faucet (4) automatically, once a degree of filling in the bathtub (1), determined by means of the remote controller (5), has been reached

14. A method according to claim 13, characterized in that it further comprises done or more of the following steps of:
placing the water level and temperature sensors (11, 12) immovably in the tub (1),
placing the water level sensor(s) (11) in a separate tracking unit (16), which is movable at least in an up/down sense on an internal surface of the tub (1),
placing at least one temperature sensor (12) in a separate tracking unit (16), which is movable at least in an up/down sense on an internal surface of the tub (1),
placing at least one temperature sensor (12) in the remote controller (5),
placing at least one temperature sensor (5) to float on the surface of bathwater (10),
providing the tub (1) with an overflow drain (2),
using a sensor for tracking the temperature of a room,
placing the tip of the filling pipe (8) and/or the overflow drain (2) behind a cover member (9),
the cover member (9) serving also as a stand for the remote controller (5),
using the remote controller (5) for controlling a drain outlet/valve present in the floor of the bathtub (1),
monitoring the temperature of bathwater (10) at an initial fill water level/14) and performing a necessary fine adjustment regarding the temperature of filling water prior to reaching a final water level (13),
adjusting the temperature of bathwater (10) during a bath by discharging water through the overflow drain (2) and/or the drain outlet/valve and by replenishing water of a desired temperature through the filling pipe (8) extending from the electronic faucet (4).

15. A method according to claim 13, characterized in that the bathtub (1) is filled and the filling process is monitored automatically.

16. A method according to claim 14, characterized in that the bathtub (1) is filled and the filling process is monitored automatically.

17. An apparatus according to claim 3, characterized in that the temperature sensor (12) floats on the surface of bathwater (10).
